(19) United States
(12) Patent Application Publication
(10) Pub. No.: US 2021/0194562 A1
(43) Pub. Date: Jun. 24, 2021

(54) BEAM RECOVERY METHOD AND DEVICE

(71) Applicant: ZTE CORPORATION, Guangdong (CN)

(72) Inventors: Yijian CHEN, Guangdong (CN); Bo GAO, Guangdong (CN); Zhaohua LU, Guangdong (CN); Chuangxin JIANG, Guangdong (CN)

(73) Assignee: ZTE CORPORATION, Guangdong (CN)

(21) Appl. No.: 17/057,759

(22) PCT Filed: May 22, 2019
(86) PCT No.: PCT/CN2019/087953

§ 371 Date: Nov. 23, 2020

(30) Foreign Application Priority Data
May 23, 2018 (CN) 201810503841.2

(51) Int. Cl. H04B 7/06; H04W 72/04; H04W 76/19; H04W 74/08

(52) U.S. Cl. CPC H04B 7/0695; H04W 72/046; H04W 72/042; H04W 74/085; H04W 76/19

(57) ABSTRACT

Provided are a beam recovery method and apparatus. The method includes: after a beam failure, performing a beam selection to select a new beam; determining a PRACH resource corresponding to the selected new beam, and sending indication information on the PRACH resource; and receiving control information sent by a base station after sending the indication information.

### TECHNICAL FIELD

The present application relates to the field of data communications and, in particular, to a beam recovery method and apparatus.

### BACKGROUND

In a radio communication system, a base station can adopt a narrower beam for transmission by using the beamforming capability of multiple antennas, effectively improving transmission efficiency. Therefore, the development trend of radio communications in the future will be that cells are divided into multiple more dynamic virtual sectors by using multiple narrow beams, so as to provide users with various services. The service range of each beam may be flexibly adjusted by using a beam weight. However, the transmission using narrow beams is relatively sensitive to the movement of a user equipment (UE) and the blocking of a beam link. In particular, at a high frequency, the blocking is severer and generally causes a link failure.

### SUMMARY

To solve the above issue, the present application provides a beam recovery method and apparatus, which can alleviate the blocking at a high frequency and reduce link failures.

The present application provides a beam recovery method. The method includes steps described below.

After a beam failure, a beam selection is performed to select a new beam.

A physical random access channel (PRACH) resource corresponding to the selected new beam is determined, and indication information is sent on the PRACH resource.

Control information sent by a base station is received after the indication information is sent.

The present application further provides a beam recovery method. The method includes steps described below.

Indication information sent by a terminal on a PRACH resource used for beam recovery is received.

After the indication information sent by the terminal is received, it is determined whether a potential conflict exists in the PRACH resource, and control information is sent in a predetermined manner.

The present application further provides a beam recovery apparatus disposed on a terminal. The apparatus includes a beam selection unit, a sending unit, and a control information receiving unit.

The beam selection unit is configured to perform a beam selection to select a new beam after a beam failure.

The sending unit is configured to determine a PRACH resource corresponding to the selected new beam and send indication information on the PRACH resource.

The control information receiving unit is configured to receive control information sent by a base station after the indication information is sent.

The present application further provides a beam recovery apparatus disposed on a base station. The apparatus includes an indication information receiving unit and a control information sending unit.

The indication information receiving unit is configured to receive indication information sent by a terminal on a PRACH resource used for beam recovery.

The control information sending unit is configured to determine whether a potential conflict exists in the PRACH resource after the indication information sent by the terminal is received, and send control information in a predetermined manner.

The present application further provides a device including a memory, a processor, and a computer program stored in the memory and executable by the processor, where the processor, when executing the computer program, implements processing of any beam recovery method provided by the present application.

The present application further provides a computer-readable storage medium, which is configured to store a computer program, where the computer program, when executed by a processor, implements processing of any beam recovery method provided by the present application.

Compared with the related art, the technical scheme provided by the present application include: after the beam failure, performing the beam selection to select the new beam; determining the PRACH resource corresponding to the selected new beam, and sending the indication information on the PRACH resource; and receiving the control information sent by the base station after sending the indication information. According to the technical scheme of the present application, the issue in the related art that a resource has to be reserved according to the worst case and cannot be occupied at any moment is improved, an effective manner for beam recovery that supports a contention mode well is provided, and the blocking at a high frequency is alleviated and link failures can be reduced.

### BRIEF DESCRIPTION OF DRAWINGS

The drawings in the embodiments of the present application are described below. The drawings in the embodiments are used for a further understanding of the present application and for explaining the present application in conjunction with the description rather than limiting the scope of the present application.

FIG. 1 is a flowchart of a beam recovery method according to an embodiment of the present application.

FIG. 2 and FIG. 3 are each a structural diagram of a beam recovery apparatus according to embodiments of the present application.

### DETAILED DESCRIPTION

For easy of understanding by those skilled in the art, the present application is further described below in conjunction with the drawings. The further description below is not intended to limit the scope of the present application. It is to be noted that if not in collision, the embodiments and various methods therein of the present application may be combined with each other.

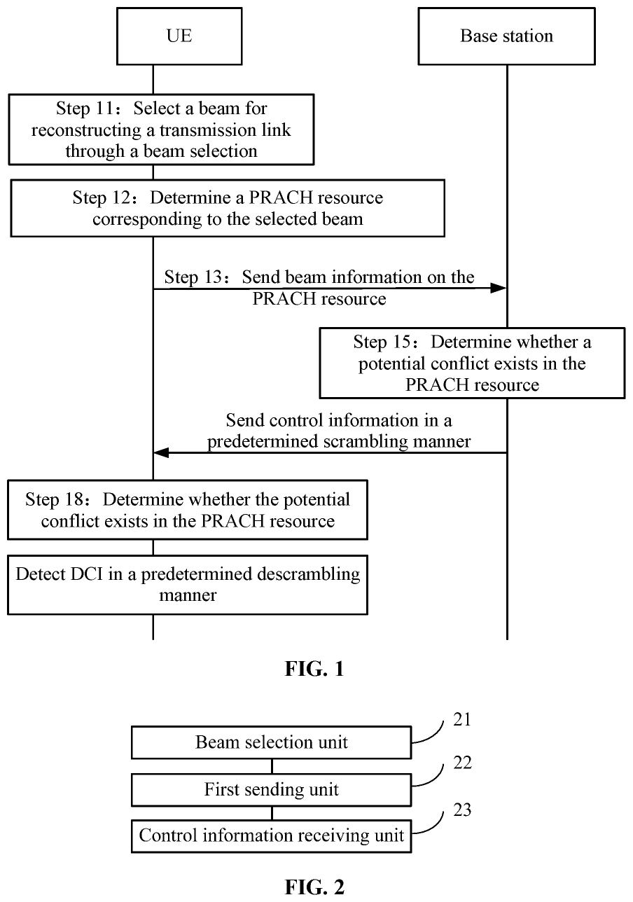

Referring to FIG. 1, the present application provides a beam recovery method. The method includes steps described below.

In step 11, after a beam failure, a terminal performs a beam selection, and selects a new beam through the beam selection.

The terminal performs determining on the beam failure through beam monitoring. In the condition of the beam failure, the terminal performs measurement in a configured or agreed reference channel set and selects a beam with higher reference signal receiving power (RSRP) as a beam that can be used for reconstructing a transmission link.

In step 12, the terminal determines a PRACH resource corresponding to the selected new beam.

In step 13, the terminal reports indication information to a base station through the PRACH resource.

The indication information includes beam recovery-related information, where the beam recovery-related information includes terminal indication information and beam indication information, etc.

In step 14, the base station receives the indication information sent by the terminal on the PRACH resource used for beam recovery.

In step 15, after the base station receives the indication information sent by the terminal, the base station determines whether a potential conflict exists in the PRACH resource and sends control information in a predetermined scrambling manner.

The predetermined scrambling manner includes at least one of sending manners described below.

In manner 1-1, if the potential conflict exists, the base station sends the control information in multiple control resource sets (CORESETs); if no potential conflict exists, the base station sends the control information in one CORESET.

In manner 1-2, if the potential conflict exists, the base station performs a response in a second control region; if no potential conflict exists, the base station performs the response in a first control region; where the response is to send the control information.

The first control region is a first beam failure recovery-control resource set (BFR-CORESET), and the second control region is a second BFR-CORESET or a random access-control resource set (RA-CORESET).

In manner 1-3, if the potential conflict exists, the base station determines multiple pieces of downlink control signaling (DCI) to be sent and performs scrambling by using multiple radio network temporary identities (RNTIs) respectively and sending; if no potential conflict exists, the base station scrambles DCI by using a cell radio network temporary identity (C-RNTI).

In manner 1-4, if the potential conflict exists, the base station determines one piece of DCI to be sent and performs scrambling by using multiple RNTIs and sending respectively; if no potential conflict exists, the base station scrambles DCI by using the C-RNTI.

In manner 1-5, if the potential conflict exists, the base station determines one piece of DCI to be sent and performs scrambling by using one RNTI and sending, where the RNTI is an RNTI corresponding to a resource used for reporting by a UE; if no potential conflict exists, the base station scrambles DCI by using the C-RNTI.

In step 17, the terminal receives the control information sent by the base station.

In step 18, the terminal determines whether a potential conflict exists in the PRACH resource and detects DCI in a predetermined descrambling manner, where the predetermined descrambling manner is a descrambling manner corresponding to the scrambling manner used by the base station.

The predetermined descrambling manner includes at least one of receiving manners described below.

In manner 2-1, if the potential conflict exists, the terminal receives the control information in multiple CORESETs; if no potential conflict exists, the terminal receives the control information in one CORESET.

In manner 2-2, if the potential conflict exists, the terminal performs receiving in the second control region; if no potential conflict exists, the terminal performs receiving in the first control region.

The first control region is the first BFR-CORESET, and the second control region is the second BFR-CORESET or the RA-CORESET.

In manner 2-3, if the potential conflict exists, the terminal determines multiple pieces of DCI to be sent and performs descrambling by using multiple RNTIs respectively and receiving; if no potential conflict exists, the terminal descrambles DCI by using the C-RNTI.

In manner 2-4, if the potential conflict exists, the terminal determines one piece of DCI to be sent and performs descrambling by using multiple RNTIs and receiving respectively; if no potential conflict exists, the terminal descrambles DCI by using the C-RNTI.

In manner 2-5, if the potential conflict exists, the base station determines one piece of DCI to be sent and performs descrambling by using one RNTI and receiving, where the RNTI is the RNTI corresponding to the resource used for reporting by the UE; if no potential conflict exists, the terminal descrambles DCI by using the C-RNTI.

The terminal and the base station agree to communicate on a control channel for beam recovery by using a beam reported by the UE. The terminal performs DCI detection on the control channel. If information of the base station is detected, it indicates that a link has been successfully established and the base station may perform a transmission of physical control information.

The base station and the terminal perform scrambling and descrambling respectively by using corresponding methods.

A description is given below in conjunction with exemplary implementation scenarios.

The present application provides a beam recovery method for dynamically selecting a control channel detection region. The method includes steps described below.

In step 101, after a beam failure, a terminal performs a beam selection to select a beam that satisfies a condition.

In step 102, a PRACH resource corresponding to the beam is determined.

In step 103, it is determined whether a potential conflict exists in the PRACH resource.

In step 104, if the potential conflict exists, the terminal detects control information in a first CORESET; if no conflict exists, the terminal detects control information in a second CORESET.

The potential conflict includes that the PRACH resource corresponding to the selected beam is a PRACH resource configured to another terminal for a random access and/or a PRACH resource configured to another terminal for beam recovery.

In an example, the first CORESET is an RA-CORESET, and the second CORESET is a BFR-CORESET.

In another example, the first CORESET is a first BFR-CORESET, and the second CORESET is a second BFR-CORESET.

In an embodiment, control information on the first CORESET is scrambled by using a first RNTI, and control information on the second CORESET is scrambled by using a second RNTI.

In an embodiment, in step 103, the terminal determines, through configuration indication information of a base station, whether the PRACH resource corresponding to the selected beam is in a potential conflict with a PRACH resource of another terminal for a random access and/or a PRACH resource of another terminal for a beam recovery, where the indication information is a broadcast message or a terminal-specific message.

The advantage of this method is that the base station can configure the PRACH resource to the terminal for the beam recovery with great flexibility. The flexibility refers to that for PRACH resources corresponding to different beams, some of them are competitive and some of them are non-competitive. PRACH resources used by different UEs for beam recovery may completely overlap, partially overlap or not overlap at all. A PRACH resource used by a UE for beam recovery and a resource used by another UE for a random access may completely overlap, partially overlap or not overlap at all.

If beam recovery that supports a contention is needed, in the previous example, the UE needs to determine whether the PRACH resource corresponding to the currently selected beam is in a potential conflict with a PRACH resource used by another UE. The other manner may be to perform a blind detection in multiple regions instead of determination.

An embodiment of the present application further provides another beam recovery method. The method includes steps described below.

In step 201, after a beam failure, a terminal performs a beam selection to select a beam that satisfies a condition.

In step 202, a PRACH resource corresponding to the beam is determined.

In step 203, a blind detection is performed on control information in at least two CORESETs, “a first CORESET and a second CORESET”.

In step 204, after the control information is detected correctly, an uplink response is performed according to the control information, where a response is needed if the mode is a contention mode.

Further, control information on the first CORESET is scrambled by using a first RNTI, and control information on the second CORESET is scrambled by using a second RNTI.

If beam recovery that supports a contention is needed, the UE may also perform the detection in one or more regions by using different RNTIs. Alternatively, an RNTI is selected for descrambling according to whether a potential conflict exists.

An embodiment of the present application further provides another beam recovery method. The method includes steps described below.

In step 301, after a beam failure, a terminal performs a beam selection to select a beam that satisfies a condition.

In step 302, a PRACH resource corresponding to the beam is determined.

In step 303, control information is descrambled by using at least two scrambling codes.

In step 304, after the control information is detected correctly, an uplink response is performed according to the control information.

An embodiment of the present application further provides another beam recovery method. The method includes steps described below.

In step 401, after a beam failure, a terminal performs a beam selection to select a beam that satisfies a condition.

In step 402, a PRACH resource corresponding to the beam is determined.

In step 403, it is determined whether a potential conflict exists in the PRACH resource.

In step 404, if the potential conflict exists, the terminal detects control information by using a first RNTI; if no conflict exists, the terminal detects control information by using a second RNTI.

If beam recovery that supports a contention is needed, another issue to be solved first is how a base station will respond after receiving beam indication information sent by a UE. A traditional method is to respond by sending control signaling scrambled by a C-RNTI on still a pre-configured BFR-CORESET (a dedicated control resource set for beam recovery).

An embodiment of the present application further provides a beam recovery method for dynamically selecting a control channel sending region or responding in multiple control regions. The method includes steps described below.

In step 501, information sent by a terminal on a PRACH used for beam recovery is received.

In step 502, it is determined whether a potential conflict exists in the PRACH resource.

In step 503, if the potential conflict exists, a base station sends control information in multiple CORESETs.

An embodiment of the present application further provides a beam recovery method. The method includes steps described below.

In step 601, information sent by a terminal on a PRACH used for beam recovery is received.

In step 602, it is determined whether a potential conflict exists in the PRACH resource.

In step 603, if the potential conflict exists, a base station responds in a second control region.

In step 604, if no potential conflict exists, the base station responds in a first control region. The first control region is a BFR-CORESET, and the second control region is a second BFR-CORESET or an RA-CORESET.

The BFR-CORESET is a dedicated region for beam recovery. The RA-CORESET is a dedicated region for a random access.

An embodiment of the present application further provides a beam recovery method. The method includes steps described below.

In step 701, information sent by a terminal on a PRACH used for beam recovery is received.

In step 702, it is determined whether a potential conflict exists in the PRACH resource.

In step 703, if the potential conflict exists, a base station responds in one of manners described below.

The base station determines multiple pieces of DCI to be sent and performs scrambling by using multiple RNTIs respectively and sending.

The base station determines one piece of DCI to be sent and performs scrambling by using multiple RNTIs and sending respectively.

The base station determines one piece of DCI to be sent and performs scrambling by using one RNTI and sending, where the RNTI is an RNTI corresponding to a resource used for reporting by a UE.

In step 704, if no potential conflict exists, the base station scrambles DCI by using a C-RNTI.

Further, the potential conflict includes that the PRACH resource is a PRACH resource configured to another terminal for a random access and/or a PRACH resource configured to another terminal for beam recovery.

If beam recovery that supports a contention is needed, another issue to be solved first is which beam recovery process a terminal should perform.

An embodiment of the present application further provides a beam recovery method. The method includes steps described below.

In step 801, a terminal reports selected indication information through a PRACH.

In step 802, the terminal determines whether a potential conflict exists in the PRACH resource.

In step 803, if the potential conflict exists, the terminal further reports user equipment identification indication information, that is, UE ID indication information after receiving a response from a base station.

In case of the conflict, the base station may not know complete UE ID information and only knows which UE set it may belong to, or even not know UE information totally. Therefore, in case of the conflict, the terminal further reports the UE ID indication information after receiving the response from the base station.

An embodiment of the present application further provides a beam recovery method. The method includes steps described below.

In step 901, a terminal reports selected indication information through a PRACH.

In step 902, the terminal descrambles control information through multiple types of RNTIs.

In step 903, it is determined whether to further report UE ID indication information according to an RNTI type corresponding to successfully detected DCI.

If different RNTI types correspond to indications for a contention and a non-contention, the terminal needs to further report the UE ID indication information in response to an RNTI type corresponding to a contention mode.

An embodiment of the present application further provides a beam recovery method. The method includes steps described below.

In step 1001, a terminal reports selected indication information through a PRACH.

In step 1002, the terminal detects control information in multiple CORESETs.

In step 1003, it is determined whether to further report UE ID indication information according to a CORESET corresponding to successfully detected DCI.

If different CORESETs correspond to indications for a contention and a non-contention, the terminal needs to further report the UE ID indication information in response to a CORESET corresponding to a contention mode.

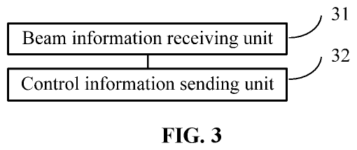

Based on the concept same as or similar to that of the preceding embodiments, an embodiment of the present application further provides a beam recovery apparatus disposed on a terminal. Referring to FIG. 2, the beam recovery apparatus provided by the present application includes a beam selection unit 21, a sending unit 22, and a control information receiving unit 23.

The beam selection unit 21 is configured to perform a beam selection to select a new beam after a beam failure.

The sending unit 22 is configured to determine a PRACH resource corresponding to the selected new beam and send indication information on the PRACH resource.

The control information receiving unit 23 is configured to receive control information sent by a base station after the indication information is sent.

The control information receiving unit 23 receives the control information sent by the base station in at least two manners.

In an embodiment of the present application, the control information receiving unit 23 receives the control information sent by the base station in at least one of manners described below.

It is determined whether a potential conflict exists in the PRACH resource; if the potential conflict exists, the control information is received in multiple CORESETs; if no potential conflict exists, the control information is received in one CORESET.

It is determined whether the potential conflict exists in the PRACH resource; if the potential conflict exists, receiving is performed in a second control region; if no potential conflict exists, the terminal performs receiving in a first control region.

It is determined whether the potential conflict exists in the PRACH resource; if the potential conflict exists, multiple pieces of DCI to be sent are determined and descrambling is performed by using multiple RNTIs respectively and receiving is performed; if no potential conflict exists, DCI is descrambled by using a C-RNTI.

It is determined whether the potential conflict exists in the PRACH resource; if the potential conflict exists, one piece of DCI to be sent is determined and descrambling is performed by using multiple RNTIs and receiving is performed respectively; if no potential conflict exists, DCI is descrambled by using the C-RNTI.

It is determined whether the potential conflict exists in the PRACH resource; if the potential conflict exists, one piece of DCI to be sent is determined and descrambling is performed by using one RNTI and receiving is performed, where the RNTI is an RNTI corresponding to a resource used for reporting by a UE; if no potential conflict exists, DCI is descrambled by using the C-RNTI.

In an embodiment of the present application, the operation in which it is determined whether the potential conflict exists in the PRACH resource includes operations described below.

It is determined whether the PRACH resource corresponding to the selected beam is a PRACH resource configured to another terminal for a random access and/or a PRACH resource configured to another terminal for beam recovery; if the PRACH resource corresponding to the selected beam is the PRACH resource configured to another terminal for a random access and/or the PRACH resource configured to another terminal for beam recovery, it is determined that the potential conflict exists; otherwise, it is determined that no potential conflict exists.

In an embodiment of the present application, the control information receiving unit 23 receives the control information sent by the base station in at least one of manners described below.

A blind detection is performed on control information in at least two CORESETs.

The control information is descrambled by using at least two scrambling codes.

In an embodiment of the present application, after the control information sent by the base station is received, the sending unit 22 is further configured to after the control information is correctly detected, perform an uplink response according to the control information.

The operation of performing the uplink response according to the control information includes reporting UE ID indication information.

In an embodiment, it is determined whether the potential conflict exists in the PRACH resource, and if the potential conflict exists, the terminal further reports the UE ID indication information after receiving the control information sent by the base station.

Alternatively, the control information is descrambled through multiple types of RNTIs, and it is determined whether to further report the UE ID indication information according to an RNTI type corresponding to successfully detected DCI.

Alternatively, control information is detected in multiple CORESETs, and it is determined whether to further report the UE ID indication information according to a CORESET corresponding to the successfully detected DCI.

Based on the concept same as or similar to that of the preceding embodiments, an embodiment of the present application further provides a beam recovery apparatus disposed on a base station.

Referring to FIG. 3, the beam recovery apparatus provided by the present application includes an indication information receiving unit 31 and a control information sending unit 32.

The indication information receiving unit 31 is configured to receive indication information sent by a terminal on a PRACH resource used for beam recovery.

The control information sending unit 32 is configured to determine whether a potential conflict exists in the PRACH resource after the indication information sent by the terminal is received, and send control information in a predetermined manner.

In an embodiment of the present application, the operation of sending the control information in the predetermined manner includes at least one of manners described below.

If the potential conflict exists, the control information is sent in multiple CORESETs; if no potential conflict exists, the base station sends the control information in one CORESET.

If the potential conflict exists, the control information is sent in a second control region; if no potential conflict exists, the base station sends the control information in a first control region.

If the potential conflict exists, multiple pieces of DCI to be sent are determined and scrambling is performed by using multiple RNTIs respectively and sending is performed; if no potential conflict exists, DCI is scrambled by using a C-RNTI.

If the potential conflict exists, one piece of DCI to be sent is determined and scrambling is performed by using multiple RNTIs and sending is performed respectively; if no potential conflict exists, DCI is scrambled by using the C-RNTI.

If the potential conflict exists, one piece of DCI to be sent is determined and scrambling is performed by using one RNTI and sending is performed, where the RNTI is an RNTI corresponding to a resource used for reporting by a UE; if no potential conflict exists, DCI is scrambled by using the C-RNTI.

The indication information receiving unit 31 is further configured to, after the control information is sent in the predetermined manner, receive UE ID indication information reported by the terminal.

Based on the concept same as or similar to that of the preceding embodiments, an embodiment of the present application further provides a device including a memory, a processor, and a computer program stored in the memory and executable by the processor, where the processor, when executing the computer program, implements processing of any beam recovery method according to the embodiments of the present application.

Based on the concept same as or similar to that of the preceding embodiments, an embodiment of the present application further provides a computer-readable storage medium, which is configured to store a computer program, where the computer program, when executed by a processor, implements processing of any beam recovery method according to the embodiments of the present application.

It is to be noted that the preceding embodiments are only for easy of understanding by those skilled in the art and not intended to limit the scope of the present application, and any apparent substitutions, improvements, and the like made by those skilled in the art to the present application without departing from the concept of the present application are within the scope of the present application.

1. A beam recovery method, comprising:
after a beam failure, performing a beam selection to select a new beam;
determining a physical random access channel (PRACH) resource corresponding to the selected new beam, and sending indication information on the PRACH resource; and
receiving control information sent by a base station after sending the indication information.

2. The beam recovery method according to claim 1, wherein receiving the control information sent by the base station in at least one of following manners:
determining whether a potential conflict exists in the PRACH resource; in response to determining that the potential conflict exists, receiving the control information in a plurality of control resource sets (CORESETs); in response to determining that no potential conflict exists, receiving the control information in one CORESET;
determining whether a potential conflict exists in the PRACH resource; in response to determining that the potential conflict exists, receiving the control information in a second control region; in response to determining that no potential conflict exists, receiving, by a terminal, the control information in a first control region;
determining whether a potential conflict exists in the PRACH resource; in response to determining that the potential conflict exists, determining a plurality of pieces of downlink control information (DCI) to be sent, and performing receiving and descrambling by using a plurality of radio network temporary identities (RNTIs) respectively; in response to determining that no potential conflict exists, descrambling DCI by using a cell radio network temporary identity (C-RNTI);
determining whether a potential conflict exists in the PRACH resource; in response to determining that the potential conflict exists, determining one piece of DCI to be sent, and performing receiving respectively and descrambling by using a plurality of RNTIs; in response to determining that no potential conflict exists, descrambling DCI by using a C-RNTI; or
determining whether a potential conflict exists in the PRACH resource; in response to determining that the potential conflict exists, determining one piece of DCI to be sent, and performing receiving and descrambling by using an RNTI, wherein the RNTI is an RNTI corresponding to a resource used for reporting by a user equipment (UE); in response to determining that no potential conflict exists, descrambling DCI by using a C-RNTI.

3. The beam recovery method according to claim 2, wherein determining whether the potential conflict exists in the PRACH resource comprises:
determining whether the PRACH resource corresponding to the selected beam is at lest one of: a PRACH resource configured to another terminal for a random access, or a PRACH resource configured to another terminal for beam recovery; in response to determining that the PRACH resource corresponding to the selected beam is at lest one of: the PRACH resource configured for another terminal for a random access, or the PRACH resource configured for another terminal for beam recovery, determining that the potential conflict exists; in response to determining that the PRACH resource corresponding to the selected beam is neither the PRACH resource configured to another terminal for a random access, nor the PRACH resource configured to another terminal for beam recovery, determining that no potential conflict exists.

4. The beam recovery method according to claim 1, wherein receiving the control information sent by the base station in at least one of following manners:
performing a blind detection on the control information in at least two CORESETs; or
descrambling the control information by using at least two scrambling codes.

5. The beam recovery method according to claim 4, after receiving the control information sent by the base station, further comprising:
after detecting the control information correctly, performing a corresponding uplink response according to the detected control information.

6. The beam recovery method according to claim 1, after receiving the control information sent by the base station, further comprising:
determining whether to report UE identification indication information according to whether a potential conflict exists in the PRACH resource; wherein in a case where the potential conflict exists, the UE identification indication information is reported; or
in a case where the control information is descrambled through a plurality of types of RNTIs, determining whether to further report UE identification indication information according to an RNTI type corresponding to successfully detected DCI; or
in a case where the control information is detected in a plurality of CORESETs, determining whether to further report UE identification indication information according to a CORESET corresponding to successfully detected DCI.

7. A beam recovery method, comprising:
receiving indication information sent by a terminal on a physical random access channel (PRACH) resource used for beam recovery; and
after receiving the indication information sent by the terminal, determining whether a potential conflict exists in the PRACH resource, and sending control information in a predetermined manner.

8. The beam recovery method according to claim 7, wherein sending the control information in the predetermined manner comprises at least one of the following:
in response to determining that the potential conflict exists, sending the control information in a plurality of control resource sets (CORESETs); in response to determining that no potential conflict exists, sending the control information in one CORESET;
in response to determining that the potential conflict exists, sending the control information in a second control region; in response to determining that no potential conflict exists, sending the control information in a first control region;
in response to determining that the potential conflict exists, determining a plurality of pieces of downlink control information (DCI) to be sent, scrambling control information by using a plurality of radio network temporary identities (RNTIs) and sending the scrambled control information; in response to determining that no potential conflict exists, scrambling DCI by using a cell radio network temporary identity (C-RNTI);
in response to determining that the potential conflict exists, determining one piece of DCI to be sent, and scrambling control information by using a plurality of RNTIs and sending the scrambled control information respectively; in response to determining that no potential conflict exists, scrambling DCI by using a C-RNTI; or
in response to determining that the potential conflict exists, determining one piece of DCI to be sent, and scrambling control information by using an RNTI and sending the scrambled control information, wherein the RNTI is an RNTI corresponding to a resource used for reporting by a user equipment (UE); in response to determining that no potential conflict exists, scrambling DCI by using a C-RNTI.

9. The beam recovery method according to claim 7, after sending the control information in the predetermined manner, further comprising:
receiving UE identification indication information reported by the terminal.

10. A beam recovery apparatus, disposed on a terminal and comprising:
a beam selection unit, which is configured to perform a beam selection to select a new beam after a beam failure;
a sending unit, which is configured to determine a physical random access channel (PRACH) resource corresponding to the selected new beam, and send indication information on the PRACH resource; and
a control information receiving unit, which is configured to receive control information sent by a base station after the indication information is sent.

11. A beam recovery apparatus, disposed on a base station and comprising a memory, a processor, and a computer program stored in the memory and executable by the processor, wherein the processor, when executing the computer program, implements processing of the method of claim 7, and the processor comprises:
an indication information receiving unit, which is configured to receive indication information sent by a terminal on a physical random access channel (PRACH) resource used for beam recovery; and
a control information sending unit, which is configured to determine whether a potential conflict exists in the PRACH resource after the indication information sent by the terminal is received, and send control information in a predetermined manner.

12. A device, comprising a memory, a processor, and a computer program stored in the memory and executable by the processor, wherein the processor, when executing the computer program, implements processing of the method of claim 1.

13. A computer-readable storage medium, which is configured to store a computer program, wherein the computer program, when executed by a processor, implements processing of the method of claim 1.

14. A computer-readable storage medium, which is configured to store a computer program, wherein the computer program, when executed by a processor, implements processing of the method of claim 7.
